(19) United States
(12) Patent Application Publication
(10) Pub. No.: US 2003/0110967 A1
(43) Pub. Date: Jun. 19, 2003

(54) Ink cartridge for ink level management apparatus

(76) Inventors: Charles K. McAnally, Farmers Branch, TX (US); Larry N. Hibbitts, Morgan, TX (US); Ralph J. Oldenkamp, Coppell, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/020,639

(22) Filed: Dec. 13, 2001

(51) Int. Cl. B41F 31/02

(52) U.S. Cl. 101/366; 101/364; 347/86

(57) ABSTRACT

An ink cartridge for an ink management system includes a piston having a stepped back surface for improved reflection of ultrasonic acoustic waves through presentation of flat surfaces normal to the incident waves, thus permitting the piston to possess a preferred cone shape and structural rigidity. Heights of steps are preferably separated by even multiples of one-quarter wavelength of incident acoustic waves to avoid destructive interference from multiple reflections. Improved reflectivity overcomes problems with using an acoustic range finder to measure the position of the piston.

### FIELD OF THE INVENTION

The invention pertains generally to and, more particularly, to ink fountains for printing presses.

### BACKGROUND OF INVENTION

Printing ink is an oily, viscous substance. It is tacky so that it will properly adhere to the image areas on the printing plate. For example, ink used to print newspapers is the least viscous, usually in the range of 50 to 80 poise. Ink for letter presses and heat-set inks employed for web offset printing have viscosities in the range of about 150 to 200 poise. Inks for sheet fed, lithographic offset printing presses are the most viscous, usually in the range of 250 to 300 poise. Newer “waterless” inks, which eliminate the need for conventional dampening systems to apply a thin film of water to the non-image areas of the printing plate, are also highly viscous and tend not to flow. Due to the printing ink's viscous nature and tendency to stick to surfaces in the ink fountain, ink will tend not to flow easily to low spots, especially when the level of the ink in the fountain is low or the printing ink is of the very viscous type used in sheet fed, lithographic offset presses. The ink level in the fountain can develop low spots, especially as the overall level of ink in the fountain drops. A low spot will lead to a thinning of the supply of film to the ink train, which in turn may result in a film which is not uniform or is discontinuously being delivered to the printing plate, resulting in poor quality prints.

To guard against accidental ink starvation, a pressman will typically fill an ink fountain with considerably more ink than might be necessary. Ink left over in the ink fountain after the end of a run or a job must be disposed of, creating cost and waste disposal problems. Automated systems for replenishing ink in ink fountains of sheet-fed, lithographic offset printing presses address these issues by keeping a minimum amount of ink in an ink fountain and guarding against low spots developing. The ink may be dispensed based on a predicated consumption rate, or it may be dispensed at specific locations in response to the system sensing a developing low spot. Examples of such systems includes those described in U.S. 2001-0011510-A1, which is incorporated herein for all purposes by reference, and those systems sold under the trademark SENTINEL by Accel Graphic Systems, Inc. of Dallas, Tex. In these systems, ink is stored in cartridges that are placed on a carriage or similar device that traverses the length of the ink fountain. After use, ink remaining in the cartridge may be stored in the cartridge for later use.

Ink is dispensed from the cartridge by applying force to a piston, plunger or similar sliding element (the term “piston” will be used to designate all such elements) that, in turn, causes displacement of ink within the cartridge through a nozzle at the end of the cartridge opposite the piston. In a typical configuration, a piston slides within an elongated hollow tube, forming a seal with the inside wall of the tube as it slides. The seal prevents ink from leaking around the piston and ink inside the cartridge from being exposed to the air. Exposing ink to air causes the ink to oxidize. The piston is preferably molded of plastic. It includes reinforcing ribs on the side opposite the ink in order to provide rigidity sufficient to avoid twisting or flexing when pressure is applied to displace the piston. Twisting or flexing would result in blowing the seal between the piston and the side of the cartridge. The ink-facing side of the piston also preferably has an outer surface that forms a cone-shape in cross-section. The cone shape tends to direct any trapped air to the perimeter when the piston is being inserted into the cartridge.

As displacement of the piston is proportional to the amount of ink dispensed, measuring displacement permits determination of the amount of ink dispensed and/or remaining in the cartridge. Displacement may be measured from a fixed point using an ultrasonic range finder. Such range finders emit a narrow beam of high frequency, or ultrasonic, accoustic pulses toward a target. The sound reflects off the target and back toward the range finder. This reflection is sometimes called an echo. The range finder measures the elapsed time between emission of the sound wave and reception of an echo and calculates a distance based on the speed of sound for the given atmospheric conditions.

### SUMMARY OF THE INVENTION

In practice it has been found that ultrasonic range finders have problems accurately measuring the distance to a piston in an ink cartridge, particular of the type described above, on a consistent basis. There are several explanations for these problems. First the back of the piston is tilted and has many surfaces that are not normal to the incident accoustic waves from a transducer. A narrow beam of acoustic energy tends to be deflected away, possibly missing the receiver. Furthermore, the surface of the target is not smooth and tends to disperse incident sound energy, thereby decreasing the magnitude of the sound echo sensed by the receiver. Second, reinforcing ribs located on the back of the piston have flat tops that present multiple parallel surfaces to the range finder. With multiple surfaces parallel to the plane of the transducer, reflections of an accoustic signal on the various surfaces tend to interfere with each other. If two surfaces are displaced in the path of the accoustic signal by an odd multiple of ¼ of the wavelength of the accoustic signal, reflections off the surfaces will be phase-shifted with respect to each other by 180 degrees, thereby canceling each other and creating ranging problems. For example, a piston for an ink cartridge may incorporate at its center a convex spheroid to create a pocket at the center of the surface facing the ink in the ink cartridge. The spherical surface will deflect all but a small portion of the sound away from the receiving transducer. Therefore, acoustic ranging the center of the piston, which is preferred in some circumstances, is not possible with this type of piston.

The invention pertains to an improved sonar target that has particular advantage for sliding pistons used to express ink from ink cartridges in ink management systems. A target according to a preferred embodiment of the present invention possesses a target area with a surface that is stepped to accommodate non-normal geometries of the target, thereby assuring that reflective surfaces are generally normal to the direction of travel of incoming acoustic waves. Furthermore, according to another aspect of the preferred embodiment, the relative heights or elevations of the steps are predominately not at odd multiples of ¼ wavelength of the acoustic waves within the area of incident acoustic energy. Relative changes in heights between adjacent steps are preferably at or substantially near even multiples of ¼ wavelength.

An ink cartridge incorporating a preferred embodiment of the invention possesses several advantages as compared to alternatives. For example, a piston of such an ink cartridge is relatively inexpensive and easy to mold as compared to, for example, a solid piston with cone shaped face and flat rear surface. The acoustic reflectivity of the piston of the ink cartridge can be made so that it is not sensitivity to the angular or rotational orientation of the ink cartridge when it is installed in an ink management system. Furthermore, any need for an insert, such as a cardboard disc, on top of a piston to present a flat target is avoided. An extra part, like the disk, increases cost of manufacture and creates a risk that a user will omit the part or the part will accidentally fall into moving parts of a press.

The forgoing summary is intended only to aid in the understanding of advantages of various aspects of a preferred embodiment and example application of the invention and not to limit the scope of the invention. The scope of the invention is defined solely by the appended claims.

### BRIEF DESCRIPTION OF THE DRAWINGS

FIG. 1 is an isometric view of an representative example of an ink management system mounted to an ink fountain of a printing press;

FIG. 2 is a side-view of the ink management system shown in FIG. 2, with an ink dispenser partially-sectioned and the ink fountain illustrated schematically; and

FIG. 3 is a cross-section of the ink cartridge, without ink, shown in FIG. 2.

### DETAILED DESCRIPTION

In the following description, like numbers refer to like parts unless the context indicates otherwise.

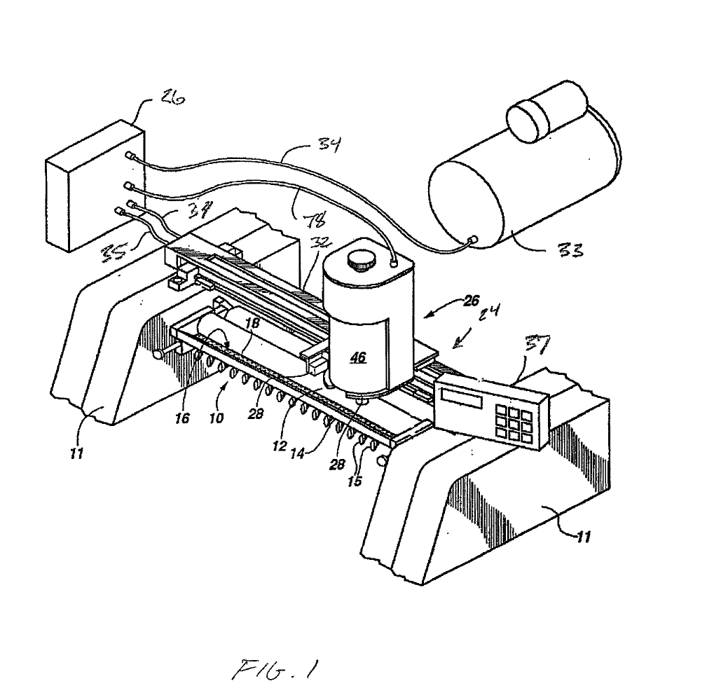

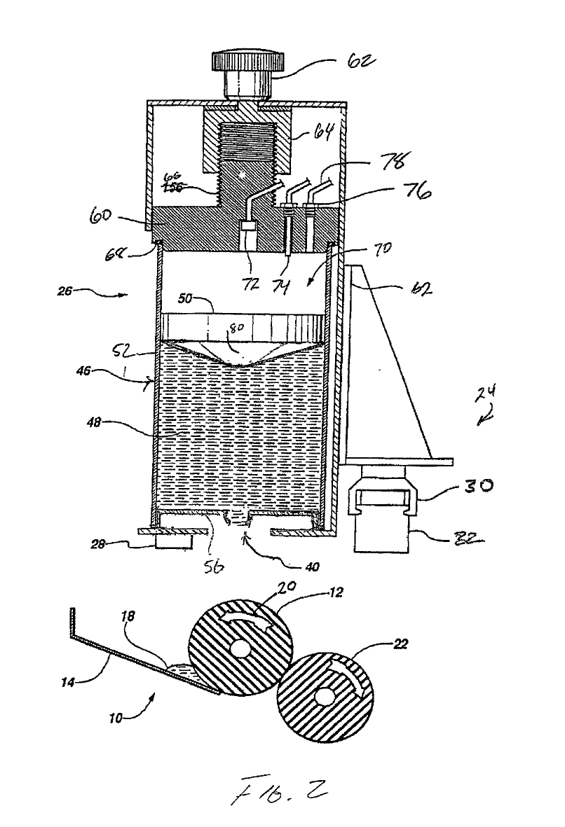

A preferred embodiment of the invention is described below in connection with a representative example of an ink management system illustrated by FIGS. 1 and 2. Although used to best advantage on a system of this type, the invention may find application in other types of ink management systems employing ink cartridges. Ink fountain 10 is supported by frame 11 of, for example, a sheet-fed lithographic printing press. Ink fountain 10 is intended to be representative of ink fountains in general that store a supply of ink and meter it for delivery to a printing plate. Ink fountain 10 includes a fountain roller 12 and blade 14 which cooperate to form an ink reservoir 16 for holding a supply of ink 18. The fountain roller rotates toward the ink reservoir, in the direction indicated by arrow 20. Ink from the reservoir is metered through a gap formed at the point at which the end of blade 14 converges with fountain roller 12. In the illustrated ink fountain, as in most ink fountains, this point is under the fountain roller, on the reservoir side. Ink tends to stick to the surface of the fountain roller as it rotates through ink 18. Ink is transferred through the gap and then to ducting roller 22 or a first roller in an ink train. Adjusting the gap between the blade and the roller changes the thickness of the layer or film of ink sticking to the surface of the fountain roller as the fountain roller rotates past the end of blade 14. The end of blade 14 is flexible so that it can be adjusted within predefined segments along the width of the ink fountain using keys 15.

Mounted on frame 11, above the ink fountain, is an ink management system. Its basic function is to maintain automatically at least a minimum level of ink in the ink fountain. It includes a linear transport generally designated as 24, an ink dispenser 26 and, preferably an ink fountain level sensor 28. The linear transport moves the ink dispenser and the ink fountain level sensor across the width of the ink fountain. The linear transport includes a carriage 30 to which is mounted the ink dispenser 26 and ink fountain level sensor 28. A drive mechanism moves and positions the carriage along the track or rail. Any type of linear transport capable of moving the ink dispenser and the ink fountain level sensor across the ink fountain could be used, such as mechanical, for example a screw, belt, cable or chain, or a pneumatic or hydraulic. In the illustrated example, a pneumatic linear actuator 32 is used. Pneumatic linear actuators are well known and operate according to well-known principles. The pneumatic linear actuator is comprised of an elongated enclosure defining an internal chamber into which compressed air may be flowed to move a carriage 30 mounted on a track formed by the elongated enclosure. The ink dispenser 26 and ink fountain level sensor 28 are mounted to carriage 30.

Compressed air for driving the pneumatic linear actuator 32 and other pneumatic systems on the ink management system and/or printing press is generated by air compressor 33. Compressed air flows through supply hose 34 to pneumatic circuits (not shown). The pneumatic circuit is operated by a process controller (not shown). The process controller could be implemented by a special purpose or a general purpose computer, an application-specific circuit, a programmable microcontroller or similar circuit or device. The pneumatic circuits include solenoid-controlled valves, flow control valves and pressure regulating valves arranged in a conventional manner to supply compressed air to the linear actuator through hoses 34 and 35 so that the carriage may be moved in either direction along its track at predetermined rates and for predetermined distances. The valves for the pneumatic circuits are located within housing 36.

Control panel 37 includes buttons to change modes of operation of the ink management system and to control manually the position of, and dispensing from, the ink dispenser when the ink management system is in a manual mode. It also includes a display that can be used to visually indicates the mode of operation and ink usage.

The linear transport, ink dispenser 26 and ink fountain level sensor 28 are oriented with respect to the ink fountain 10 such that nozzle 40 of ink cartridge 46 traverses or moves laterally across the width of the ink fountain above the fountain roller 20 and the ink fountain level sensor traverses the ink fountain above the ink 18 in reservoir 16. The ink dispenser is preferably mounted on the carriage using arm 42 so that the linear transport can be located in a position which does not interfere with dispensing operations. Ink fountain level sensor 28 is mounted on an arm 43 which extends outwardly over the ink fountain, but to one side of the ink dispenser. As the carriage traverses the ink fountain during sensing and dispensing operations, the ink fountain level sensor leads the ink dispenser. If ink fountain level sensor 28 senses a low spot, the ink dispenser, once it moves over the low spot, dispenses ink at that spot. The ink sensor may be a photoelectric, accoustic, magnetic, optical, electric, or other type of sensor that can sense distance to ink 18 in the ink fountain, preferably in a noninvasive manner. The distance may be sensed, for example, by determining whether the ink surface is within or outside a set distance from the sensor, or by measuring the actual distance. Having the ink fountain level sensor 28 lead the ink dispenser 26 enables the sensor to make one or more readings, before deciding whether additional ink is required in that segment and before the ink dispenser is positioned next to the segment for dispensing.

Nozzle 40 is located over the fountain roller 12. Ink that is dispensed falls onto the fountain roller and is then carried by the fountain roller towards the metering gap between blade 14 and fountain roller 12. The fountain roller effectively forces the ink into the area of convergence between blade 14 and the fountain roller 12, thus helping to ensure that enough ink is present at the metering gap to provide a continuous and uniform supply of ink. As there is little or no reliance on flowing of ink, the level of ink in the fountain may be kept very low, even with very viscous ink. Preferably, the amount of ink which is dispensed is such that a small bead of ink is set up and maintained by the ink management system in the area of the convergence of blade 14 and roller 12 as a consequence of depositing the ink on the roller and the rolling action of the fountain roller.

Decisions to dispense ink are preferably based on more than one reading or measurement by ink level sensor 28. For example, the width of the ink fountain can be logically divided into segments or increments for purposes of level sensing and dispensing of ink. The segments could, if desired, correspond to the segments of blade 14 controlled by each of a plurality of keys 15. The level or amount of the ink in the segment would preferably then be determined based on a series of readings taken across the segment. The ink dispenser, once it is centered over the segment, dispenses the ink if the level is below a present level or amount. Alternatively, a decision can be made based the last N number of samples, which may correspond to some distance presuming the ink dispenser and sensor move at a constant rate. In this case, the decision to dispense is made, in effect, based on a moving segment or window. In either case, if the resolution of the sensor is relatively high, it is preferred to take to base the decision on multiple readings, as the ink, due to its viscous nature, will have surface ripples or irregularities, such that any single reading may either be inaccurate or not representative of the level of ink. For example, if readings or samples are binary—one value means ink level is below a set level, and a second value indicates that it is above that level—equaling and/or exceeding some threshold number of the readings or samples indicating a low ink level would trigger a dispense. Readings could also be integrated or averaged, for example, to make a decision.

A supply of ink stored by ink dispenser 26 in a removable ink cartridge 46 containing a supply of ink 48. The ink dispenser includes a means for applying a force to a sliding, disc-shaped piston or plunger 50. Displacement of piston 50 causes ink to be dispensed through nozzle 40. Piston 50 also seals one end of the cartridge so that air cannot reach ink 48. Any suitable means for applying force may be used, including, for example, mechanical mechanisms and gas (e.g. air) or liquid pressure. Examples of mechanical mechanisms include, but are not limited to, screws and hydraulically, pneumatically, and electro-magentically actuated devices.

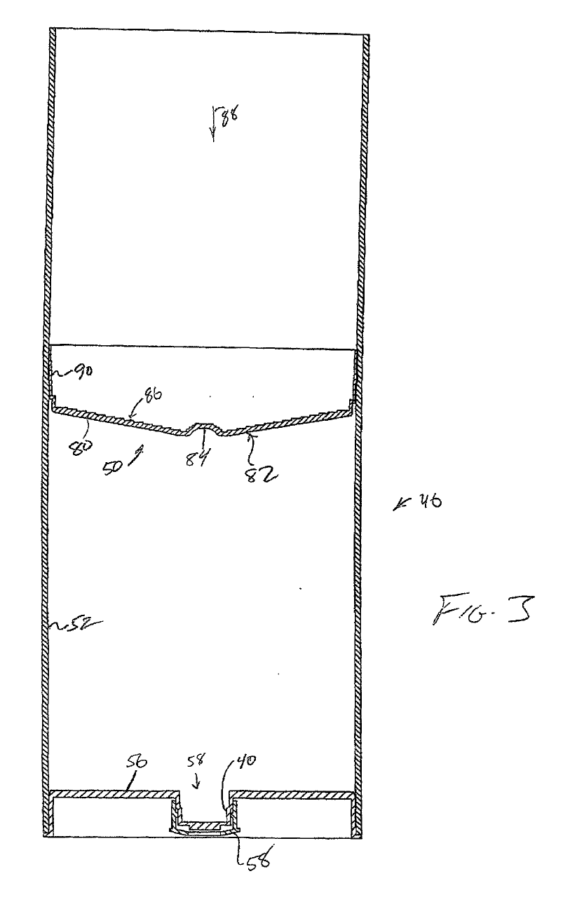

Referring now to FIGS. 2 and 3, cartridge 46 preferably possesses the shape of a tube. Though such shape works best for pushing ink out of the cartridge, other shapes could be employed. Wall 52 forms the tube shape. Although indicated as having only a single layer, the side wall may be made of multiple layers if desired. A top end of the cartridge preferably defines an opening 54 and a bottom end of the cartridge is closed by bottom wall 56. The opening in the top need only be large enough to apply a force to piston 50 and measure its displacement. The bottom wall can be formed, for example, by a molded piece of plastic or a metal plate. The bottom wall has formed in it an opening 58, through which ink may flow out of the cartridge and into nozzle 40. It is preferred that nozzle 40 be integrally molded with the bottom wall 56 in order to simply manufacture. However, it may be attached to the wall as a separate piece. Cap 58 fits over the nozzle to seal the cartridge and prevent or reduce oxidation of the ink. Ink is preferably shipped and stored in the cartridge. Ink remains in a cartridge after its use during a printing job can be stored in the cartridge by remaining from the ink dispenser and capping the nozzle.

In a preferred embodiment illustrated in the figures, pneumatic head 60 applies force to piston 50 of ink cartridge 46. Frame 62 supports ink cartridge 46 and pneumatic head 60. When supplied with compressed air, the compressed air flows through pneumatic head 60 and into a sealed chamber created by the pneumatic head, the wall of the open end of cartridge 46 and piston 50. The air pressure within the sealed chamber exerts an even force across piston 50 of the ink cartridge, thereby displacing the piston, which in turn displaces some of the supply of ink 48 through nozzle 40. In order to move the pneumatic head against the cartridge, knob 62 is manually rotated. Rotation of the knob rotates internally threaded, cylindrically-shaped coupling 64. Rotating coupling 64 moves rod 66 linearly due to external threads on the rod mating with those on the inside of coupling 64. Translation of rod 66 extends and retracts the pneumatic head 60, to which the rod is attached. However, other mechanisms of moving the pneumatic head into position against the top of the cartridge can be used, such as pneumatic and hydraulically actuated mechanisms. For example, pneumatic pressure can be used to move the pneumatic head against the cartridge.

Gasket 68 seals the pneumatic head to a top edge of the cartridge when the pneumatic head is moved against the cartridge, thereby sealing volume 70 as a pressure chamber. Volume 70 is defined within the cartridge, between side wall 52 and extending from a back side of piston 50 to a top edge of wall 52.

Mounted within a hollow passage defined through the center of pneumatic head 60 is an ultrasonic, range-finding transducer 72 for use in determining the distance to the piston 50 of the ink cartridge. Transducer emits accoustic waves toward piston 50, and detects incident accoustic waves reflected from piston 50. By measuring this distance and knowing the dimensions of the ink cartridge and the position of the transducer relative to the cartridge, the ink remaining in the cartridge and the amount of ink dispensed during a known interval, for example during a job, can be determined. To compensate for changes in the velocity of sound cause by temperature (i.e. density) variations, the temperature of the air within volume 70 is measured using temperature probe 74. Compressed air enters the sealed chamber of volume 70 through inlet port 76. Inlet port 76 is connected with supply hose 78. The pressure within the chamber determines the rate at which ink is dispensed from nozzle 40. The ink within the cartridge will not flow through the nozzle 40 without applying at least a minimum pressure to piston 50 in excess of the atmospheric pressure. A valve (not shown) is opened for connecting compressed air to the pneumatic head 60 and another valve (not shown) is opened to the vent of the chamber when the compressed air is disconnected.

As best seen in FIG. 3, piston 50 is comprised of a wall 80 having a cone shaped front surface 82 on its front side, with a spherically-shaped, concave center portion 84. Rear or back surface 86 of the piston forms a target for the ultrasonic transducer 72. The rear surface 86 of the piston is, in the preferred embodiment, the back side of wall 80. Side wall 90 of piston 50 is biased outwardly against wall 52 in order to form a seal that prevents ink from flowing around the sides of piston 50 when pressure is applied to the piston. Air pressure also tends to push side wall 90 against the inside surface of wall 52.

As it is preferred that the thickness of wall 80 be at least relatively constant, if not also relatively thin, the rear surface 86 is stepped to accommodated the slope of the wall, and its bulging center portion 84, with surfaces that are oriented either generally normal to or parallel with the direction of incident acoustic waves from transducer 72. This direction is generally indicated by arrow 88 in FIG. 3. When piston 50 is viewed from this direction, the steps appear as concentric rings. Visible surfaces are oriented so that they are generally flat and normal to the direction of travel of the incident waves. Incident acoustic waves will reflect primarily off of the normal surfaces. The relative elevations or heights of the steps, as measured along the direction indicated by arrow 88, are preferably at or about even multiples of ¼ the wavelength of the incident accoustic waves in order to avoid destructive interference. Destructive interference between reflections of the acoustic waves off of two surfaces occurs when the two surfaces are separated in the direction of the travel of the waves by odd multiples of ¼ wavelength. Although it is preferable that elevation of the steps be separated by even multiples of ¼ wavelength, elevation differences could be permitted to deviate from this ideal separation. The degree of deviation may depend in the beam width, the width of the steps, the total change in elevation between, for example, the step at the center of the beam and steps at the perimeter of the beam, and the sensitivity of the acoustic receiver. For example, if the steps are not in even multiples of ¼ wavelength with respect to each other, accumulated deviation from this ideal spacing over a series of steps may result in two steps within an area of incident acoustic energy that are nearing or at an undesirable spacing of an odd multiple of ¼ wavelength. If the lateral distance between steps with elevation or height differences that are closer to an odd multiple of ¼ wavelength are within the area of incident acoustic energy, some destructive interference between waves reflected off of these surfaces will likely occur. However, some destructive interference can be tolerated, so long as the return signal remains strong enough for reliable detection. Furthermore, the difference in elevation between the destructively interfering steps may be sufficient to allow a portion of an acoustic return to reach a range finder sensor before interference takes place.

The figures show the entire rear surface 86 of piston 50 being covered with steps. This permits an acoustic range finder to be aimed anywhere on the piston. However, a smaller target area may be defined, with steps being located only in an area or areas where a beam of acoustic energy from the range finder could be aimed. For example, if the transducer is aimed within an area between the center of the piston and some radius extending from the piston, concentric steps extending from the center to a distance approximately equal to the radius would permit a cartridge to be installed at any rotational orientation. Furthermore, the steps do not have a ring configuration, though such configuration is preferred for a symmetrical, circular piston. For example, the steps could be square or rectangular in surface shape to accommodate elevational changes in two directions. The steps need not all be the same shape.

The forgoing description is of a preferred embodiment of the invention and is intended only to illustrate rather than define the invention. Modifications, substitutions and rearrangements of the forgoing embodiment may be made without departing from the scope of the invention defined by the appended claims and equivalents thereof.

What is claimed is:

1. An ink cartridge for an ink management system comprising a container filled with ink, the container having at one end an outlet; and a sliding piston disposed within the container, displacement of which causes ink to be expressed through the outlet, the sliding piston having an exposed rear surface, at least a portion of which includes a plurality of steps having substantially flat surfaces facing the same direction.

2. The ink cartridge of claim 1, wherein the plurality of steps have relative heights with respect to each other such that destructive interference in a echo of an incident acoustic reflected off of multiple ones of the plurality of steps, signal is sufficiently reduced to permit accurate detection of the acoustic signed by a range finder.

3. The ink cartridge of claim 2 wherein the relative changes in heights of adjacent ones of the plurality of steps are at or substantially near even multiples of ¼ wavelength of the incident acoustic waves in order to substantially reduce destructive interference between the incident waves reflecting off of the steps when an acoustic wave beam is incident on multiple ones of the plurality of steps.

4. An ink cartridge for an ink management system comprising:
a hollow body storing ink;
an exit opening defined through a closed end of the body;
a piston within the body that slides along the hollow body when force is applied to the piston, the piston having a generally cone-shaped cross-section with a front surface facing toward the exit opening and a rear surface having an acoustic range finding target area with a plurality of steps facing the same direction.

5. The ink cartridge of claim 3 wherein the steps are concentrically arranged.

6. The ink cartridge of claim 4 wherein the relative heights between adjacent ones of the plurality of steps are at or substantially near even multiples of ¼ wavelength of the incident acoustic waves in order to substantially reduce destructive interference between waves reflecting off of the steps when an acoustic wave beam is incident on multiple ones of the plurality of steps.

7. The ink cartridge of claim 4, wherein the steps have relative heights between adjacent ones of the plurality of steps that are substantially at or near even multiples of ¼ wavelength of acoustic waves of a range finder in order to substantially reduce destructive interference between waves reflecting off of the steps when an acoustic wave beam is incident on multiple ones of the plurality of steps.

8. An ink cartridge for an ink management system comprising:
a hollow body storing ink;
an exit opening defined through a closed end of the body;
a piston within the body that slides along the hollow body when force is applied to the piston, the piston having a generally cone-shaped cross-section with a front surface facing toward the exit opening and a rear surface having an acoustic range finding target area with a plurality of steps facing the same direction; the steps being concentrically arranged and having relative heights between adjacent ones of the plurality of steps that are substantially at or near even multiples of ¼ wavelength of acoustic waves of a range finder in order to substantially reduce destructive interference between waves reflecting off of the steps when an acoustic wave beam is incident on multiple ones of the plurality of steps.

9. An ink cartridge for an ink management system comprising a container filled with ink, the container having at one end an outlet; and
a sliding piston disposed within the container, displacement of which causes ink to be expressed through the outlet, the sliding piston having an exposed rear surface, at least a portion of which includes a plurality of steps having substantially flat surfaces facing the same direction;
wherein the relative heights of adjacent ones of the plurality of steps are at or substantially near even multiples of ¼ wavelength of incident acoustic waves in order to substantially reduce destructive interference between waves reflecting off of the steps when an acoustic wave beam is incident on multiple ones of the plurality of steps.

10. An ink management system comprising a means for traversing an ink fountain of a printing press; and an ink cartridge mounted to the means for traversing ink;
a range finder;
wherein the ink cartridge comprises:
an ink cartridge for an ink management system comprising a container filled with ink, the container having at one end an outlet; and a sliding piston disposed within the container, displacement of which causes ink to be expressed through the outlet, the sliding piston having an exposed rear surface, at least a portion of which includes a plurality of steps having substantially flat surfaces facing the same direction.

11. The ink cartridge of claim 10, wherein the plurality of steps have relative heights with respect to each other such that destructive interference in a echo of an incident acoustic reflected off of multiple ones of the plurality of steps, signal is sufficiently reduced to permit accurate detection of the acoustic signed by a range finder.

12. The ink cartridge of claim 11 wherein the relative changes in heights of adjacent ones of the plurality of steps are at or substantially near even multiples of ¼ wavelength of the incident acoustic waves in order to substantially reduce destructive interference between the incident waves reflecting off of the steps when an acoustic wave beam is incident on multiple ones of the plurality of steps.
